(19) United States
(12) Patent Application Publication
(10) Pub. No.: US 2005/0198837 A1
(43) Pub. Date: Sep. 15, 2005

(54) Shaving razors with multiple blades

(76) Inventor: Stephen Rawle, Newbury (GB)

Correspondence Address: FISH & RICHARDSON PC, 225 FRANKLIN ST, BOSTON, MA, 02110, US

(21) Appl. No.: 10/798,112

(22) Filed: Mar. 11, 2004

(51) Int. Cl. B26B 21/00

(52) U.S. Cl. 30/346.57; 30/50

(57) ABSTRACT

A shaving razor blade unit including a housing, and a shaving surface defined by a group of at least five parallel blades supported by the housing, the distance from the cutting edge of a first blade of the group to a last blade of the group being between 3.8 mm and 4.6 mm.

### BACKGROUND OF THE INVENTION

The invention relates to shaving razors with multiple blades.

In recent years shaving razors with various numbers of blades and geometries have been proposed in the patent literature and commercialized, as described, e.g., in U.S. Pat. No. 6,212,777 and U.S. Published patent applications Nos. 2002/0144404 A1 and 2002/0157259 A1.

Increasing the number of blades on a shaving razor generally tends to increase the shaving efficiency of the razor and provide better distribution of compressive forces on the skin but it can also tend to increase drag forces, reduce maneuverability, and reduce the ability to trim. Increasing the number of blades also requires increasing the area occupied by blades or reducing the spacing between the cutting edges of the blades. Increasing the area occupied by blades can affect shaving performance. Reducing the spacing between blades results in a change on the skin bulge between cutting edges and the effectiveness of the shave, potentially requiring changes in other parameters in blade geometry such as blade tangent angle and exposure. Increasing the number of blades can also affect the rinsability of the razor, which affects the ability to remove shaving debris from the blade area.

### SUMMARY OF THE INVENTION

The invention features, in general, a shaving razor blade unit including a housing, and a shaving surface defined by a group of at least five parallel blades supported by the housing, the distance from the cutting edge of a first blade of the group to a last blade of the group being between 3.8 mm and 4.6 mm, preferably between 4.0 mm and 4.4 mm, and most preferably between 4.1 mm and 4.3 mm.

Particular embodiments of the invention may include one or more of the following features. In particular embodiments, the span between cutting edges is between 0.95 mm and 1.15 mm, preferably between 1.0 mm and 1.1 mm, most preferably about 1.05 mm. The exposure of blades between the first blade and said the blade is approximately 0.0. The blades have a blade tangent angle between 18° and 25°, preferably between 20° and 23°, most preferably about 21.5°. The first blade has a negative exposure. The last blade has a positive exposure. The blades are movably mounted with respect to the housing, e.g., on support members that are movably mounted on the housing.

Embodiments of the invention may include one or more of the following advantages. Shaving razor blade units provide good force distribution over many blades and improved shaving performance without increasing the area taken up by the blade units to too large an extent while retaining rinse-through capability.

Other advantages and features of the invention will be apparent from the following description of particular embodiments and from the claims.

### BRIEF DESCRIPTION OF THE DRAWINGS

FIG. 1 is a perspective view of a shaving razor.

FIG. 2 is a perspective view of the FIG. 1 razor showing its replaceable cartridge separated from its handle.

FIG. 3 is vertical sectional view showing the relative positions of some of the components of a cartridge of the FIG. 1 razor.

FIG. 4 is a top view of a cutting member of the FIG. 3 cartridge.

FIG. 5 is a front view of the FIG. 4 cutting member.

FIG. 6 is a vertical sectional view of the FIG. 4 cutting member.

FIG. 7 is an enlarged vertical sectional view of the FIG. 4 cutting member.

### DETAILED DESCRIPTION OF PARTICULAR EMBODIMENTS

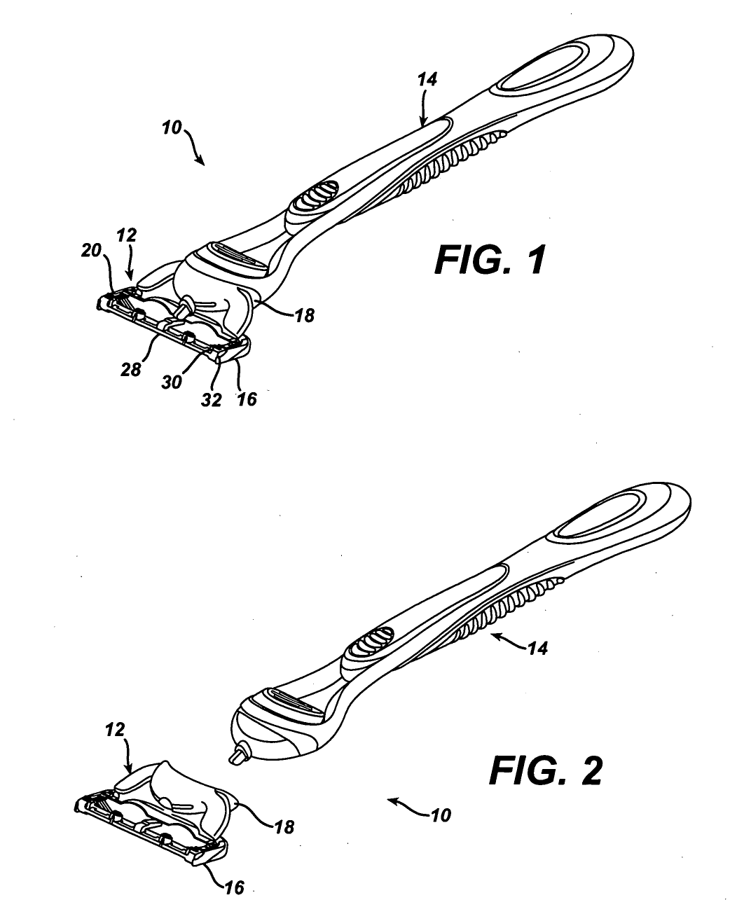

Referring to FIGS. 1 and 2, shaving razor 10 includes disposable cartridge 12 and handle 14. Cartridge 12 includes a connecting member 18, which connects to handle 14, and a blade unit 16, which is pivotally connected to connecting member 18. Blade unit 16 includes plastic housing 20, primary guard 22 at the front of housing 20, cap 24 with lubricating strip 26 at the rear of housing 20, five elongated blades 28 between primary guard 22 and primary cap 24, and trimming blade assembly 30 attached to the rear of housing 20 by clips 32, which also retain blades 28 on housing 20.

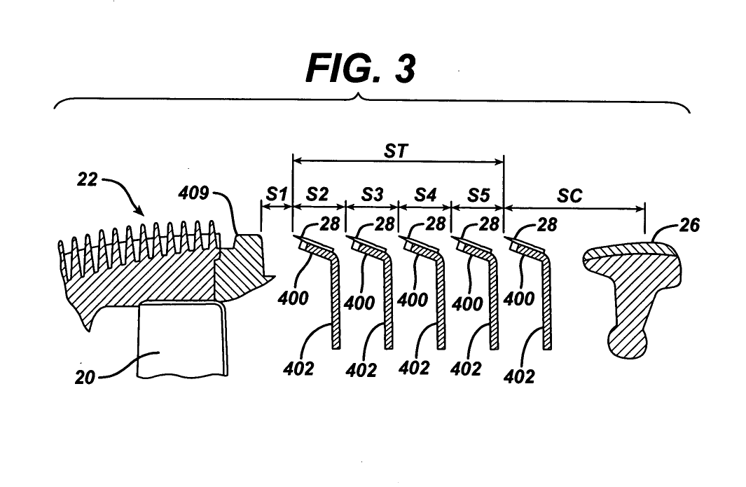

Referring to FIGS. 3-6, it is seen that each elongated blade 28 is supported on a respective elongated bent support 400 having an elongated lower base portion 402, an elongated bent portion 404 and an elongated platform portion 406 on which the blade 28 is supported. The blade span is defined as the distance from the blade edge to the skin contacting element immediately in front of that edge as measured along a tangent line extending between the element and the blade edge. The cutting edges 406 of each blade are separated from cutting edges 408 of adjacent blades by the inter-blade span distance S2=S3=S4=S5; the inter-blade span is between 0.95 mm and 1.15 mm, preferably between 1.0 mm and 1.1 mm and most preferably about 1.05 mm. The blade exposure is defined to be the perpendicular distance or height of the blade edge measured with respect to a plane tangential to the skin contacting surfaces of the blade unit elements next in front of and next behind the edge. Because the cutting edges all rest against clips 32 when at rest, they are in a common plane, such that the exposures of the three intermediate blades are zero. The front blade 28 has a negative exposure of −0.04 mm, and the last blade 28 has a positive exposure. The decreased exposure on the first blade and increased exposure on the last blade provides for improved shaving performance as described in U.S. Pat. No. 6,212,777. The span S1 from the front rail 409 to the cutting edge of the front blade 28 is 0.65 mm, and the distance SC from the cutting edge of the last blade 28 to the tangent point on lubricating strip 26 of cap 24 is 3.16 mm.

The increased number of blades tends to desirably distribute compressive forces of the blades against the skin, but will increase the area taken up by the blades if the spans remain the same, with potential difficulties in maneuverability and trimming. Reducing spans for an increased number of blades tends to desirably reduce the overall area taken up by blades and to reduce the bulge of skin between cutting edges with a potential improvement in comfort. Reducing the span, however, can reduce the rinsability and ability to clear shaving debris from the blade area. In a five-bladed razor, the lower end of the span range of 0.95 mm provides good comfort but increased potential for problems associated with clearing shaving debris, and the upper end of the span range of 1.15 mm provides good clearing of shaving debris but potential for skin bulge and decreased comfort, such that span values within the range, and in particular, values closer to the most preferred 1.05 mm span, provide a good balance of reduced size and good comfort while maintaining sufficient rinsability to avoid shaving debris problems. The distance ST from the first cutting edge 408 to the last cutting edge 408 is four times the inter-blade span and thus is between 3.8 mm and 4.6 mm, preferably between 4.0 mm and 4.4 mm and most preferably about 4.2 mm, i.e., between 4.1 mm and 4.3 mm.

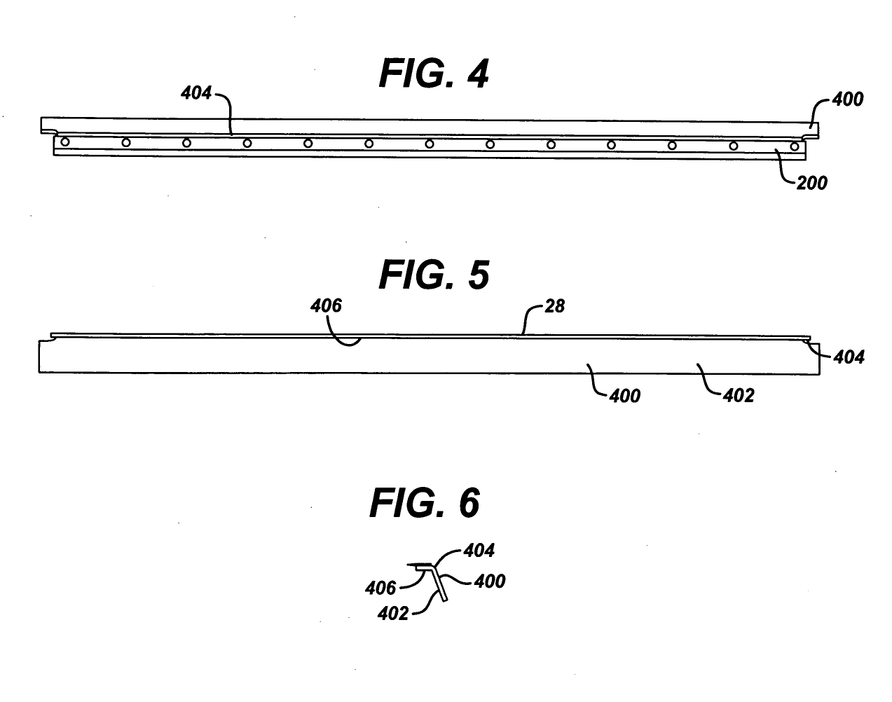

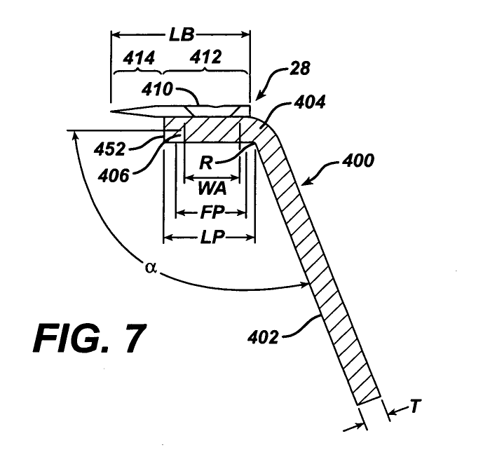

Referring to FIGS. 4-7, blade 28 is connected to platform portion 406 by thirteen spot welds 410 applied by a laser that melts the metal of blade 28 at the weld area WA to create molten metal, which forms the weld 410 to platform portion 406 upon cooling. The weld area WA is an area of attachment at which the blade is secured to the platform portion. The weld area WA is located within a flat portion FP of platform portion 406. The blade length LB from cutting edge 408 to blade end 450 is less than 1 mm, preferably less than 0.9 mm, and most preferably about 0.85 mm. Blade 28 has a uniform thickness portion 412 that is supported on platform portion 406 and a tapered portion 412 that extends beyond the front end 452 of platform portion 406.

Elongated bent metal support 400 is made of metal that is between 0.004″ and 0.009″ thick (dimension T), preferably metal between 0.005″ and 0.007″ thick, and most preferably metal about 0.006″ thick. Platform portion 406 has a length LP length from its front end 452 to the bent portion 404 less than 0.7 mm, preferably less than 0.6 mm, and most preferably about 0.55 mm. The bent portion 404 has an inner radius of curvature R that is less than 0.1 mm, preferably less than 0.09 mm and most preferably less than 0.08 mm. The angle α between base portion 402 and platform portion 406 is between 108° and 115°, preferably between 110° and 113°, most preferably about 111.5°.

Other embodiments of the invention are within the scope of the appended claims.

1. A shaving razor blade unit comprising
a housing, and
a shaving surface defined by a group of at least five parallel blades supported by said housing, the distance from the cutting edge of a first blade of said group to a last blade of said group being between 3.8 mm and 4.6 mm.

2. The blade unit of claim 1 wherein said distance is between 4.0 mm and 4.4 mm.

3. The blade unit of claim 1 wherein said distance is between 4.1 mm and 4.3 mm.

4. The blade unit of claim 1 wherein the span between cutting edges is between 0.95 mm and 1.1 mm.

5. The blade unit of claim 1 wherein the exposure of blades between said first blade and said last blade is approximately 0.0.

6. The blade unit of claim 1 wherein said blades have a blade tangent angle between 21° and 22°.

7. The blade unit of claim 1 wherein said first blade has a negative exposure.

8. The blade unit of claim 1 wherein said last blade has a positive exposure.

9. The blade unit of claim 1 wherein said blades are movably mounted with respect to said housing.

10. The blade unit of claim 5 wherein said blades are mounted on support members that are movably mounted on said housing.

11. A shaving razor blade unit comprising
a housing, and
a shaving surface defined by a group of at least five parallel blades supported by said housing, said blades having an average interblade span between 0.95 mm and 1.15 mm.
